(19) United States
(12) Patent Application Publication
(10) Pub. No.: US 2025/0065656 A1
(43) Pub. Date: Feb. 27, 2025

(54) PLASTIC PRODUCT AND A METHOD FOR APPLYING AN IMPRINT TO A PLASTIC PRODUCT

(71) Applicant: Ritter GmbH, Schwabmünchen (DE)

(72) Inventors: Samuel KREBBER, Königsbrunn (DE); Frank FINIS, Augsburg (DE); Florian BRANDHUBER, Augsburg (DE)

(21) Appl. No.: 18/810,867

(22) Filed: Aug. 21, 2024

(30) Foreign Application Priority Data
Aug. 21, 2023 (DE) 102023122329.1

(51) Int. Cl. B41M 1/30; B41M 7/00

(52) U.S. Cl. CPC B41M 1/30; B41M 7/00

(57) ABSTRACT

A plastic product includes a printing field, wherein an imprint is applied to the printing field by a digital direct printing process, wherein UV ink or UV color is used as the printing medium. A method for applying an imprint to a plastic product includes: (a) providing the plastic product having a plastic body and a printing field provided on the plastic body, and (b) printing a printed image by direct application of a printing agent in a digital printing process, wherein the printing agent is a fluorescent printing agent.

### FIELD

The present disclosure relates to a plastic/resin product comprising a printing field, and a method for applying an imprint to a plastic product.

### INTRODUCTION

Plastic products are widely used because they are light, cheap to manufacture, robust, and therefore practical. Plastic products and plastic packaging are indispensable in various applications, including cartridges for the storage of chemicals for construction purposes, such as silicone, acrylic, etc., in the medical field, such as disposable syringes, disposable pipette tips, PCR component plates, containers for the same, etc.

Information may be attached to the plastic components for tracking and categorization, e.g. labels with corresponding information and coding. However, the components are often small, a product may consist of several individual components and/or there may be no position on the component where a label could be attached without disturbing the end customer's perception. Furthermore, the end customer is usually not interested in information on manufacturing data, lot or charge information, and information on the supply chain of the component.

### SUMMARY

Based on this, the present disclosure provides a plastic product that is provided with tracing information, whereby the end customer does not readily perceive this information.

The present disclosure provides a plastic product comprising a printing field, wherein an imprint is applied to the printing field using a digital direct printing process, wherein UV ink or UV color (i.e. colorless fluorescent ink/color) is used as the printing medium.

In particular, the imprint comprises at least one product code and/or brand information for tracking the manufacturing data and/or the supply chain of the product.

Using the presently described systems and methods, discrete labelling with product codes and brand information may be applied to the plastic products, via which the entire supply chain may be traced (product traceability).

Colorless fluorescent UV ink/color is only visible under UV light and is therefore generally not visible to the end consumer. UV ink is colorless under normal lighting conditions and fluoresces bluish under black light. Depending on the solvent of the ink/color, the ink/color may have good adhesion properties on a variety of different substrates, including plastic or various coatings underneath the print (e.g. visible prints/labels). In a production line, for example, the UV print can be printed onto the plastic product as part of the labelling process.

UV imprints may be read under UV light on dark substrates or glossy layers. The imprint may be highly durable. In particular, the quality of the imprint may withstand difficult environmental conditions, e.g. use of the plastic product in a laboratory autoclave.

The imprint provided for ensuring complete traceability may be a barcode, a QR code, or similar.

Detection is carried out, for example, by a scanner and a black light tube designed for UV ink. These devices may be used at dedicated points within the production line or in the logistics chain where the code is checked for readability or where it is read out. Codes for storing the information in the UV imprint may, for example, be scanned before a component (plastic product) of a multi-component product (various plastic products) are assembled.

The information stored in the imprint is linked to the imprint for example in a database, so that properties (such as production lot, batch, brand, component type, etc.) of the plastic product may be clearly identified.

In particular, a digital direct printing process, such as a pad printing, a laser printing, and/or an inkjet printing process, may be used. The process may be selected so that the resolution and reproducibility of an imprint are sufficient even when only small printing fields are available.

The plastic product may be a cartridge for holding filling material, a tray for holding sample wells, a pipette tip, plastic packaging, or similar.

However, the application of the claimed technology is not limited, but it may be applied to all kinds of other plastic products, e.g. cosmetics, pharmaceutical products, processed food containers and other consumer goods.

A method for applying an imprint to a plastic product may include:
(a) providing the plastic product with a plastic body having a printing field, and
(b) printing a printed image by directly applying a printing agent to the printing field in a digital printing process, wherein the printing agent comprises fluorescent UV ink or fluorescent UV color.

UV ink or UV color comprises all printing agents that are invisible when exposed to visible light but emit visible light when exposed to UV light, e.g. by fluorescence. In the context of this application the terms “UV ink” and “UV color” include fluid and solid UV colors, for example, corresponding toners. UV ink/UV color is usually colorless. However, alternatively it may have a coloring that is adapted to the substrate in such a way that it is not visible under the incidence of visible light, i.e., the imprint is not readable under visible light radiation. In other words: in the context of this invention, the term “colorless” is also intended to include embodiments, wherein the UV ink/UV color is colored, but does not have sufficient contrast to the background. Therefore, the imprint may only be recognized and read under UV radiation.

### BRIEF DESCRIPTION OF THE DRAWINGS

FIG. 1a a side view of a container for pipette tips;

FIG. 1b a top view of a lid of the container of FIG. 1a;

FIG. 2a a side view of a container for pipette tips with UV illumination;

FIG. 2b a top view of a lid of the container of FIG. 2a.

### DETAILED DESCRIPTION

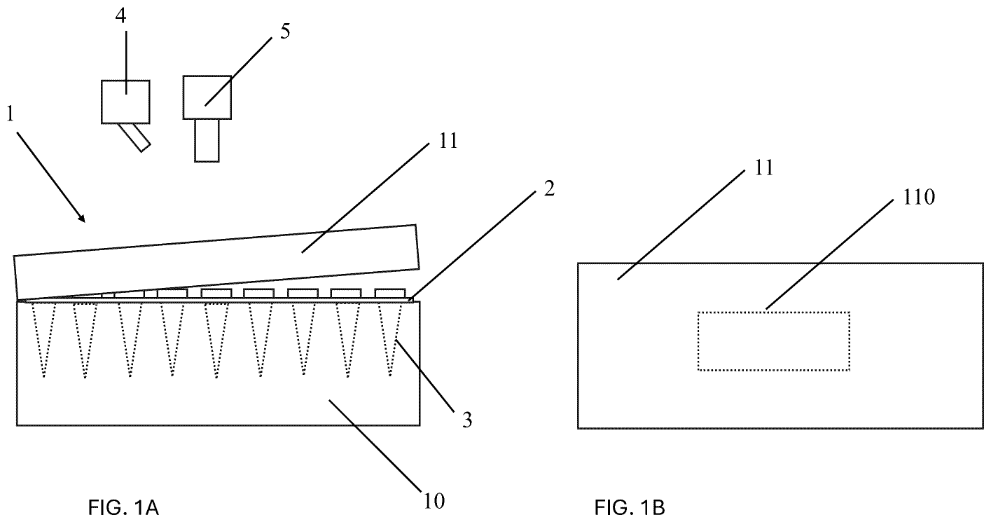

FIG. 1a shows a container 1 for pipette tips in a side view. The container 1 comprises a receptacle 10 and a lid 11. A tray 2 with openings for receiving and holding pipette tips 3 is inserted into the receptacle 10.

A UV light source 4 is arranged within a production or analysis station. The UV light source may illuminate the lid 11 from above. Also above the lid 11 there is a detector (e.g. digital camera) 5 for recording pictures in the visible light spectrum. The detector 5 covers at least a predetermined area 110 (indicated by dashed lines) of the lid surface. This area 110 may be labeled using UV color or UV ink.

Since the UV light source 4 is switched off in FIGS. 1a and 1b, the camera 5 detects/records the area 110 as an “unlabeled” area.

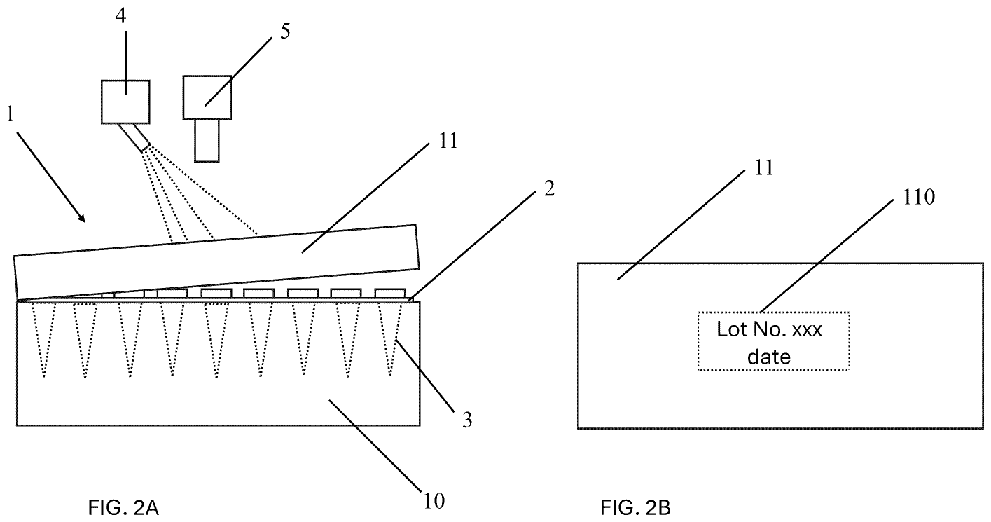

The same container 1 for pipette tips is shown in a side view in FIG. 2a.

The UV light source 4 arranged in the production or analysis station is now switched on and irradiates at least the area 110 of the lid surface 11. Since in FIGS. 2a and 2b the UV light source 4 is switched on, the camera 5 detects and records the area 110 as a “labeled” area, i.e. the camera 5 detects/records the visible light emitted by the UV ink/UV color. Various information such as lot number, date of manufacture, etc., may be written in the area 110.

In particular, the components 10, 11, 2 may be arranged in such a way that an area of the tray 2 or an area of the receptacle 10 labeled with UV color or UV ink may be detected.

In this way, information about the individual components such as the receptacle 10, the lid 11, the tray 2, etc., may be attached to the components without them being visible to the consumer without a UV light source 4. The information may relate to details about manufacturing, logistics, etc., of the component.

### CONCLUSION

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

1. A plastic product comprising a printing field, wherein an imprint is applied to the printing field by a digital direct printing process, wherein the printing medium comprises UV ink or UV color.

2. The plastic product according to claim 1, wherein the imprint comprises at least one product code and/or brand information for tracking the manufacturing data and/or information on the supply chain of the product.

3. The plastic product according to claim 1, wherein the plastic product is a cartridge for receiving filling material, a tray for holding sample wells, a pipette tip, or a plastic package.

4. The plastic product according to claim 1, wherein the digital direct printing process comprises a laser printing process, a pad printing process and/or an inkjet printing process.

5. A method for applying an imprint to a plastic product, the method comprising:
(a) providing the plastic product having a plastic body and a printing field provided on the plastic body, and
(b) printing a printed image by direct application of a printing agent in a digital printing process, wherein the printing agent comprises a fluorescent printing agent.

6. The method according to claim 5, wherein step (b) comprises the use of a digital direct printing process.

7. A method for reading an imprint provided on a plastic product according claim 1, comprising irradiating the imprint with ultraviolet (UV) light and detecting the visible light emitted by the imprint.
